(19) United States
(12) Patent Application Publication
(10) Pub. No.: US 2026/0084303 A1
(43) Pub. Date: Mar. 26, 2026

(54) METHOD AND DEVICE FOR CONTROLLING A ROBOT

(71) Applicant: Robert Bosch GmbH, Stuttgart (DE)

(72) Inventors: Moritz Diehl, Freiburg (DE); Christian Heinzemann, Vellmar (DE); Eslam Salah Zaki Elshiekh, Metzingen (DE); Jan Staschulat, Weil Der Stadt (DE); Niels Van Duijkeren, Kornwestheim (DE); Ralph Lange, Rutesheim (DE); Yunfan Gao, Sindelfingen (DE)

(21) Appl. No.: 19/110,116

(22) PCT Filed: Nov. 14, 2023
(86) PCT No.: PCT/EP2023/081770

§ 371 Date: Mar. 10, 2025

(30) Foreign Application Priority Data
Nov. 17, 2022 (DE) 10 2022 212 272.0

(51) Int. Cl. B25J 9/16

(52) U.S. Cl. CPC B25J 9/1664

(57) ABSTRACT

A computer-implemented method for ascertaining a control signal of a robot. The method includes: obtaining a position and movement direction of an object; ascertaining a first set of reachable positions of the object with respect to at least one physical model of the movement of the object and a set of time points, wherein the reachable positions of the first set are characterized by a set of first circles which are each assigned to a time point; ascertaining a trajectory of the robot, which is characterized by positions of the robot at time points, wherein each position is characterized by at least one second circle, which corresponds to the time point of the position; ascertaining the control signal depending on whether at a given time point the second circle corresponding to the time point intersects with the first circle corresponding to the time point or touches the first circle.

### FIELD

The present invention relates to a method for ascertaining a control signal of a robot, a control device, a robot, a computer program, and a machine-readable storage medium.

### BACKGROUND INFORMATION

Liu et al, 2017, “Provably Safe Motion of Mobile Robots in Human Environments” describes an online verification method for verifying the safety of robot trajectories.

Designing the movement of robots in such a way that they are safe in relation to their environment is a challenging task. Mobile robots in particular typically interact with an environment that also contains other moving objects, such as people or other robots. Such a robot is required not to collide with other objects in its environment.

For solving this problem, Liu et al. (2017) present a method that can be used to examine a robot's trajectory to examine whether it is safe, i.e., whether the robot will not collide with people within a predefined time horizon. The method uses so-called reachable sets of positions that the objects and the robot can reach within the time horizon, in order to evaluate the safety of a robot's trajectory. For this purpose, Liu et al. use polygonal hulls of the reachable set of objects and the robot and calculate whether these hulls intersect or not.

### SUMMARY

The inventors were able to specify that the method of Liu et al. is not real-time capable, especially for mobile robots, which are typically characterized by limited computing capacities due to the use of embedded computing systems.

Advantageously, a method having features the present invention is capable of evaluating a trajectory of a robot in terms of its safety with respect to other objects in an environment of the robot, wherein considerably less computing capacity is required for the evaluation. Therefore, the method is particularly suitable for use during the runtime of a robot and can be carried out by the robot itself.

In a further aspect, the present invention relates to a computer-implemented method for ascertaining a control signal of a robot. According to an example embodiment of the present invention, the method comprises the steps of:
obtaining a position and a movement direction of at least one object in an environment of the robot;
ascertaining a first set of reachable positions of the object with respect to at least one physical model of the movement of the object and a set of time points, wherein the reachable positions of the first set are characterized by a set of first circles and the first circles are each assigned to a time point from the set of time points;
ascertaining a trajectory of the robot, wherein the trajectory is characterized by positions of the robot at time points from the set of time points, wherein each position is characterized by at least one second circle corresponding to the time point of the position;
ascertaining the control signal depending on whether, at a given time point, the second circle corresponding to the time point intersects with the first circle corresponding to the time point or touches the first circle.

The method can be understood as being executed under the conventional sense-plan-act paradigm (the three steps in robotics of detecting a robot's environment, planning an action and executing the action) during the plan phase. During this phase, the robot preferably has information about the robot's environment in the form of a virtual environment; for example, relevant objects and their positions can be symbolically usable by the robot. Relevant objects can include, in particular, moving objects, such as persons, animals, vehicles or other robots.

The method of the present invention can be understood in such a way that it ascertains whether a planned trajectory will lead to a collision with the object. If the method of the present invention ascertains that the trajectory will lead to a collision or that a collision is likely, the robot can then be controlled accordingly to avoid the collision.

In various embodiments of the present invention, it can be provided that the position of the object and the robot are represented in a two-dimensional plane. This is typically described in the literature as the bird's eye view (BEV). A two-dimensional plane is particularly advantageous if the height of the robot and/or the objects is not relevant and collisions between the robot and the objects along a length and a width of the robot are to be prevented.

In the method according to an example embodiment of the present invention, one, preferably all, positions of relevant objects in the environment are first provided to the robot. This can be done in particular by a method for object detection based on sensor data from the robot or the environment, for example by object detection based on camera or LIDAR images from the robot. The object detection method can in particular be carried out based on a machine learning method.

In addition, according to an example embodiment of the present invention, the movement direction of the object is passed to the method. The movement direction can also be estimated as part of the object detection method or ascertained via a tracking method and based on previously detected positions of the object.

For the obtained positions, the method then predicts how at least one object might move within the environment. For this purpose, possible positions of the object are determined for a set of future time points based on a physical model of the model's movement. In particular, a velocity model or an acceleration model can be used as a physical model.

The possible positions, which can also be denoted as the reachable set, can be ascertained in particular based on expected physical conditions. For example, when using an acceleration model, it can be assumed that a pedestrian (as an example of an object) cannot reach an acceleration greater than an anatomically plausible limit. An anatomically plausible maximum speed can also be specified for a velocity model.

Preferably, according to an example embodiment of the present invention, at each time point from the set of time points, a set of positions can be ascertained at which a corresponding object could plausibly be located. In the method, first circles are used in the space of the positions at each of these time points, each circle being assigned to a time point and characterizing the reachable positions for the object with respect to the physical model at the time point assigned to the first circle.

In addition, according to an example embodiment of the present invention, the method ascertains a set of second circles. The second circles can be understood as the enclosing shell of the robot in the virtual environment. At the time points at which a first circle was ascertained, planned positions of the robot can now be ascertained along the trajectory, for example a desired trajectory of the robot, wherein at each position a second circle describes an occupancy of a part of the space of the virtual environment.

If at a time point the first circle corresponding to the time point does not intersect with the second circle corresponding to the time point or touches the second circle, the object and the robot cannot occupy the same position at the same time and thus a collision cannot occur at that time point. Preferably, this is ascertained for all time points in the set of time points in order to specify whether the trajectory of the robot is collision-free at each time point.

Depending on this statement, a control signal can then be determined which causes a specific action of the robot. For example, the robot can follow the trajectory if it has been specified that at no time point does a first circle intersect with a second circle. Otherwise, the control signal can cause the robot to carry out a safety maneuver. The control signal can, for example, cause the robot to stop. Alternatively or additionally, the control signal can also cause a change in the trajectory. For example, the control signal can cause an autonomous vehicle (as an embodiment of the robot) to drive onto a shoulder and stop there. Other safety maneuvers are also possible and depend on the specific environment and the specific task of the robot.

The method of the present invention differs from conventional methods in particular in the calculation of the intersection between the robot and the set of reachable positions of the object in the virtual environment. In the conventional method, the intersection of reachable positions based on an acceleration model and reachable positions from a velocity model is defined as the reachable set of positions of an object. This intersection is described in the related art as a polygon.

Advantageously, no intersection is formed by polygons or using polygons in the method. Instead, at the corresponding time points it is calculated whether two circles intersect or touch. Whether two circles touch or intersect can be advantageously ascertained by comparing the sum of the radii of the two circles and the distance between the centers of the two circles. These calculations, which are economical from the computer's point of view, result in an acceleration of the calculation time and thus an acceleration of the method for ascertaining the control signal. In other words, the computationally intensive examination of intersections of polygons is replaced by the much faster calculation of the distance between circles.

The inventors were able to specify that the method can be accelerated by at least three orders of magnitude using the same hardware. This makes the method real-time capable when using current embedded computers for robots.

According to an example embodiment of the present invention, preferably, the method can also provide for a plurality of first circles to be ascertained at each time point from the set of time points, wherein a first circle is ascertained based on a physical model of a plurality of physical models of the movement of the object and the control signal is ascertained depending on whether a second circle corresponding to a time point intersects with all first circles of the plurality of circles ascertained for this time point.

This preferred embodiment of the present invention can be understood in such a way that there is a plurality of different physical models, each describing a movement of the object. At each time point in the set of time points, each model can ascertain a set of reachable positions, which in turn can be represented as first circles. Advantageously, the method does not combine the reachable positions of different models into a polygon; instead, each can be evaluated individually. This means that a second circle corresponding to a time point can be examined with respect to touching or intersecting all the first circles determined for that time point and by the various physical models. A collision can occur if (at a certain time point) the second circle intersects with and/or touches all of the first circles. Advantageously, in this form of the method the ascertainment can also be based solely on the ascertainment of the distances between circles, thus allowing the method to be accelerated compared to conventional methods, even when using multiple models.

Physical models that can be used include, for example, velocity models and acceleration models.

In various embodiments of the present invention, it can be provided that a position of the robot along the trajectory is characterized by a plurality of second circles.

For example, it is possible that the robot has a cuboid shape from a bird's eye view. In these cases, it can be provided that at each time point from the set of time points a set of second circles characterizes the robot in the virtual environment. In this case, the intersection with the first circles can be carried out for all second circles at one time point and the trajectory for this time point can be determined as safe if none of the second circles intersects with a first circle. When using a plurality of physical models and thus a plurality of first circles per time point, it can be determined individually for each second circle whether the second circle intersects with all the first circles. If a second circle intersects with all the first circles at a time point, this can be understood to mean that the planned trajectory may lead to a collision.

Advantageously, these embodiments of the present invention can prevent modelings of the robot in the virtual environment that extend unnecessarily excessively beyond the actual robot shape. This allows trajectories to be evaluated as safe, which would otherwise be considered unsafe due to the oversized modeling of the robot (i.e., would be evaluated as involving a collision with the object).

In particular, in the various embodiments of the present invention, it can be provided that the set of time points characterizes a period of time that the robot needs for performing a safety maneuver.

This can be understood as meaning that the trajectory of the robot only needs to be checked for the periods of time required to execute a safety maneuver. In principle, the robot's trajectory can also be planned for longer periods of time, but the set of time points can be kept so short that it only covers the time necessary for a safety maneuver. If different safety maneuvers can be controlled via the control signal, the period of time can in particular correspond to the longest safety maneuver or to a preferred safety maneuver.

In various embodiments of the present invention, it can also be provided that a first circle and/or a second circle contains an uncertainty with respect to the position of the object or the position of the robot.

The circles can be understood as enclosing an actual position of an object or the robot. However, when perceiving objects, it can happen that the real position of the objects in the physical world is not represented accurately enough in the virtual environment (e.g., due to insufficiently precise detection of the objects in the physical world). Similarly, it can happen that a real position of the robot in the physical world cannot be represented accurately enough in the virtual environment (e.g., because the position of the robot is ascertained based on odometry, which may be subject to blurring). For safety reasons, a circle can therefore be extended. In cases where uncertainty with respect to a position can be quantified (e.g., uncertainty values such as variances in object detection using machine learning techniques), an expansion of a circle can also be proportional to the uncertainty value.

Advantageously, according to an example embodiment of the present invention, this can further increase the safety of the robot's navigation in the physical world.

Furthermore, in various example embodiments of the present invention, it can be provided that the radii of two first circles, which correspond to successive time points, and/or two second circles, which correspond to successive time points, are selected such that the corresponding circles touch or intersect.

First circles or second circles can be arranged, based on the time point assigned thereto, in ascending chronological order corresponding to the time points. The circles characterize time-discrete regions, whereas in the real world, time-continuous processes take place. In order to counteract this blurring, successive circles can be selected from a temporal perspective to be at least large enough that they touch each other. Advantageously, the time points between these two circles are considered in a “smoothed” state.

For this purpose, for temporally consecutive first circles and/or temporally consecutive second circles, the corresponding circles can be extended to such an extent that they touch or overlap. If two consecutive circles already touch or intersect, an extension can be omitted.

In a further aspect, the present invention relates to a control device, wherein the control device is configured to ascertain a control signal according to the method of the present invention for ascertaining the control signal and to control a robot according to the control signal.

The control device can be physically located in the robot, for example as part of the robot's electronics. Alternatively, it is also possible for the control device to be spatially separated from the robot. For example, the control device can be located in a data center with which the robot communicates via cable or wirelessly.

In the various embodiments of the present invention, it can also be provided that a plurality of objects in the physical world are located in an environment of the robot and the method is carried out for at least a subset of the objects, preferably for all objects. Preferably, the method of the present invention can be carried out individually for each object.

Example embodiments of the present invention will be explained in detail below with reference to the figures.

### BRIEF DESCRIPTION OF THE DRAWINGS

FIG. 1 schematically shows a method controlling a robot, according to an example embodiment of the present invention.

FIG. 2 schematically shows a method for controlling a cuboid-shaped robot, according to an example embodiment of the present invention.

FIG. 3 schematically shows a structure of a control system for controlling a robot, according to an example embodiment of the present invention.

FIG. 4 schematically shows an exemplary embodiment for controlling an at least partially autonomous robot, according to the present invention.

### DETAILED DESCRIPTION OF EXAMPLE EMBODIMENTS

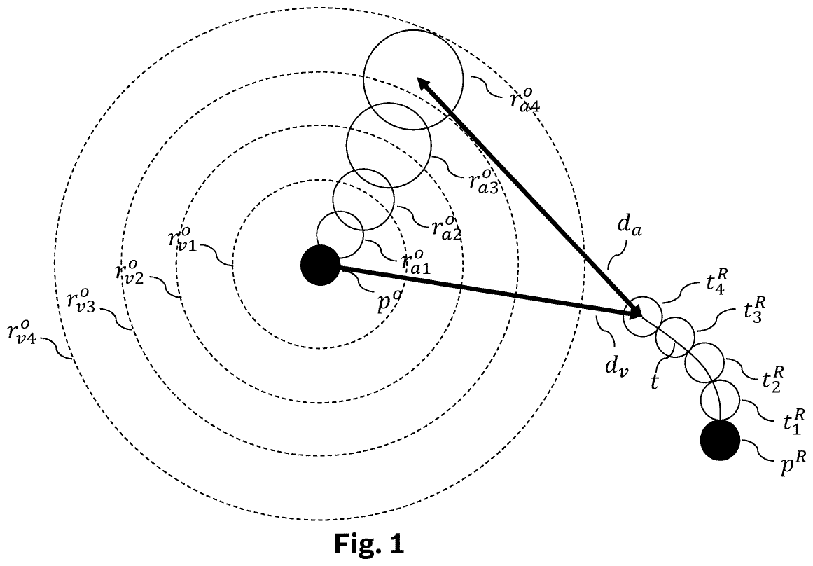

FIG. 1 shows schematically a method for ascertaining a control signal of a robot.

The method is provided with a position (p^{o}) of an object in an environment of the robot, a position (p^{R}) of the robot and a desired trajectory (t) of the robot.

Based on a velocity model, the method then ascertains, for each time point from a set of time points (four time points in the exemplary embodiment), a region in which the object can plausibly be located at the corresponding time point. The corresponding regions at the given time points are indicated by first circles

$$( {r}_{v 1}^{o} , {r}_{v 2}^{o} , {r}_{v 3}^{o} , {r}_{v 4}^{o} ) .$$

Preferably, based on an optional acceleration model in the method, a further range can be ascertained for each time point in which the object can plausibly be located based on accelerations of the object. The corresponding regions of the acceleration model at the given time points are characterized by further first circles

$$( {r}_{a 1}^{o} , {r}_{a 2}^{o} , {r}_{a 3}^{o} , {r}_{a 4}^{o} ) .$$

The velocity model can be characterized in particular by a maximum speed vₘₐₓ which the object can plausibly assume. The maximum speed is a parameter of the method and can be set in particular based on the class of the object (pedestrian, vehicle, animal, . . . ). This allows determination of where the object may be located at any time point in the future starting from the position (p^{o}) of the object.

Likewise, the acceleration model can be optimized in particular by a maximum acceleration aₘₐₓ which the object can plausibly assume. The maximum acceleration is a parameter of the method and can be set based on the class of the object. This allows starting from the position (p^{o}) of the object and a known velocity for any time point where the object may be in the future. For example, the speed of the object can be estimated directly by a machine learning system or based on tracking the object over a plurality of time steps.

In addition, based on the trajectory (t), desired positions can be ascertained for the robot at the given time points. The respective positions are characterized in the exemplary embodiment by second circles

$$( {t}_{1}^{R} , {t}_{2}^{R} , {t}_{3}^{R} , {t}_{4}^{R} ) ,$$

which are each designed to enclose the robot.

At each time point (shown as an example for time point 4), it is then ascertained whether a second circle

$$( {t}_{4}^{R} )$$

at this time point intersects with a first circle

$$( {r}_{v 4}^{o} ) ,$$

optionally with ail first circles

$$( {r}_{v 4}^{o} , {r}_{a 4}^{o} )$$

ascertained for a time point. For this purpose, a first distance (dᵥ) of the center of the first circle

$$( {r}_{v 4}^{o} )$$

to the center of the second circle

$$( {t}_{4}^{R} )$$

can be ascertained. If the additional acceleration model is used, a second distance (dₐ) of the center of the further first circle

$$( {r}_{a 4}^{o} )$$

to the center of the second circle

$$( {t}_{4}^{R} )$$

can be ascertained. If both respective distances (dₐ,dᵥ) are larger than the corresponding sums of the radii of the circles used to calculate the corresponding distance, the corresponding circles do not intersect or touch. In this case, the position of the robot can be considered safe at the corresponding time point.

The step of determining the intersections of the circles can preferably be carried out for each time point. If the intersections are empty at any time point and for any circle, the trajectory (t) can be assessed as safe and a control signal can be determined, which moves the robot along the trajectory. Otherwise, a control signal can be detected that causes the robot to carry out a safety maneuver.

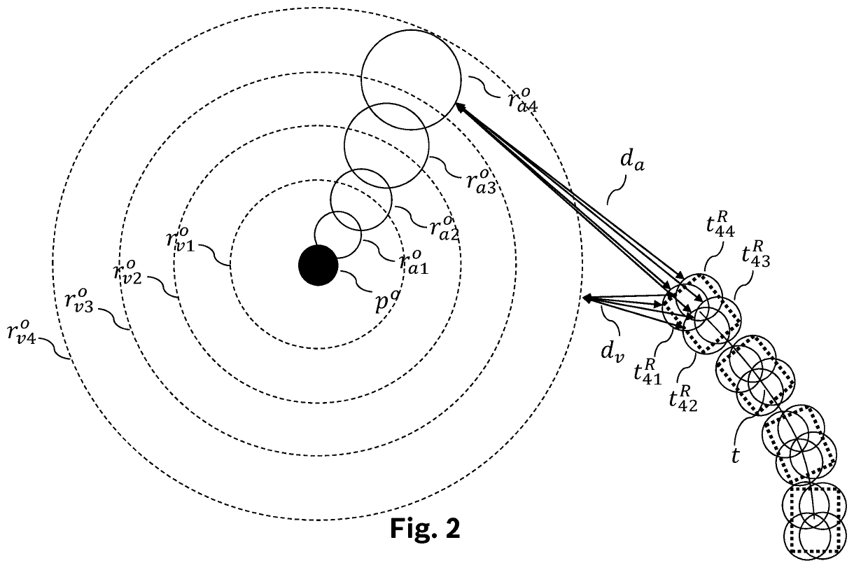

FIG. 2 shows an embodiment of the method from FIG. 1, in which the robot is cuboid-shaped and is guided for each time point by a plurality of second circles

$$( {t}_{41}^{R} , {t}_{42}^{R} , {t}_{43}^{R} , {t}_{44}^{R} ) .$$

The exemplary embodiment is substantially identical to the exemplary embodiment in FIG. 1 with the difference that for the intersection calculation at a time point a corresponding first circle

$$( {r}_{v 4}^{o} , {r}_{a 4}^{o} )$$

is examined with regard to an intersection with all second circles

$$( {t}_{41}^{R} , {t}_{42}^{R} , {t}_{43}^{R} , {t}_{44}^{R} )$$

and the trajectory (t) is classified as safe if no second circle

$$( {t}_{41}^{R} , {t}_{42}^{R} , {t}_{43}^{R} , {t}_{44}^{R} )$$

intersects with or touches the first circles

$$( {r}_{v 4}^{o} , {r}_{a 4}^{o} ) .$$

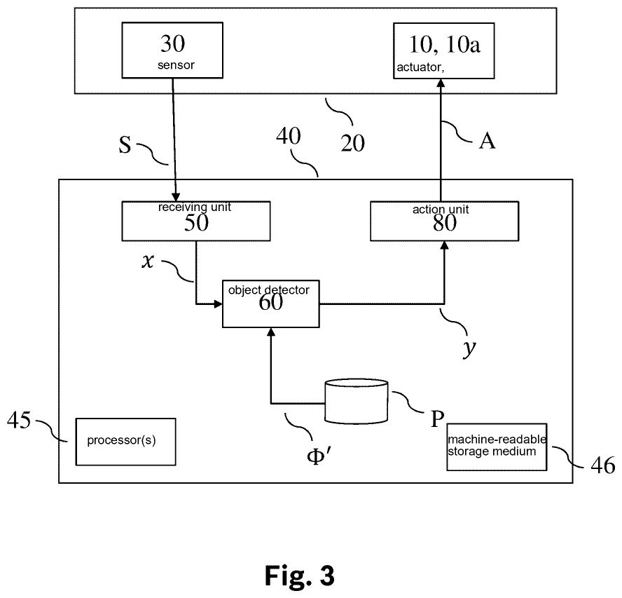

FIG. 3 shows a control system (40) that is designed to control a robot based on the method from FIG. 1 or 2. The control system (40) is designed to ascertain a control signal (A) of an actuator (10), wherein the actuator (10) controls a movement of the robot. At preferably regular time intervals, a surrounding region (20) of the actuator (10) is detected using a sensor (30), in particular an imaging sensor such as a camera sensor, which can also be provided by a plurality of sensors, for example a stereo camera. The sensor signal(S)—or, in the case of a plurality of sensors, one sensor signal(S) each—of the sensor (30) is transmitted to the control system (40). The control system (40) thus receives a sequence of sensor signals (S). The control system (40) ascertains control signals (A) therefrom, which are transmitted to the actuator (10).

The control system (40) receives the sequence of sensor signals(S) from the sensor (30) in an optional receiving unit (50), which converts the sequence of sensor signals(S) into a sequence of input signals (x) (alternatively, the sensor signal(S) can also be adopted directly as the input signal (x)). The input signal (x) can, for example, be a portion or a further processing of the sensor signal(S). In other words, the input signal (x) is ascertained according to sensor signal(S). The sequence of input signals (x) is fed to an object detector (60).

The object detector (60) is configured to ascertain objects on the input signals (x). The object detector (60) is preferably a model from the field of machine learning, in particular a neural network.

The object detector (60) is preferably parametrized by parameters (@), which are stored in a parameter memory (P) and are provided by said memory.

The object detector (60) ascertains from the input signals (x) output signals (y), which characterizes the position of detected objects. The output signals (y) are fed to an action unit (80), which ascertains therefrom control signals (A), which are fed to the actuator (10) in order to control the actuator (10) accordingly. The action unit (80) is designed to carry out the method of FIG. 1 or FIG. 2.

The actuator (10) receives the control signals (A), is controlled accordingly and performs a corresponding action. Here, the actuator (10) can comprise a control logic (not necessarily structurally integrated), which ascertains, from the control signal (A), a second control signal with which the actuator (10) is then controlled.

In further embodiments, the control system (40) comprises the sensor (30). In still further embodiments, the control system (40) alternatively or additionally also comprises the actuator (10).

In further preferred embodiments, the control system (40) comprises at least one processor (45) and at least one machine-readable storage medium (46) on which instructions are stored that, when executed on the at least one processor (45), cause the control system (40) to perform the method according to the present invention.

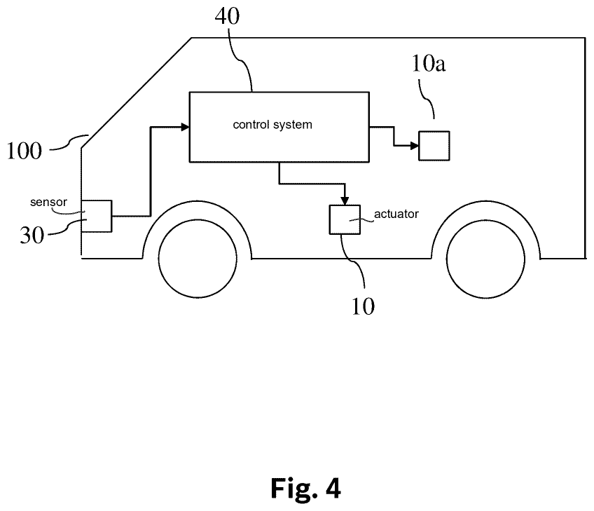

FIG. 4 shows how the control system (40) can be used to control an at least partially autonomous robot, in this case an at least partially autonomous motor vehicle (100).

The sensor (30) can, for example, be a video sensor preferably arranged in the motor vehicle (100).

The actuator (10), which is preferably arranged in the motor vehicle (100), can be, for example, a brake, a drive or a steering system of the motor vehicle (100). The control signal (A) can then be ascertained such that the actuator or actuators (10) are controlled such that the motor vehicle (100) prevents, for example, a collision with the objects identified by the machine object detector (60).

Alternatively, the at least partially autonomous robot can be another mobile robot (not shown), for example one that moves by flying, swimming, diving or walking. The mobile robot can, for example, be an at least partially autonomous lawnmower or an at least partially autonomous cleaning robot. In these cases as well, the control signal (A) can be ascertained in such a way that the drive and/or steering system of the mobile robot are controlled in such a way that the at least partially autonomous robot prevents a collision with objects identified by the object detector (60).

The term “computer” includes any device for processing specifiable calculation rules. These calculation rules can be in the form of software, or in the form of hardware, or even in a mixed form of software and hardware.

In general, a plurality can be understood as indexed, i.e., each element of the plurality is assigned a unique index, preferably by assigning consecutive integers to the elements contained in the plurality. Preferably, when a plurality comprises N elements, where N is the number of elements in the plurality, the elements are assigned integers from 1 to N.

1-12. (canceled)

13. A computer-implemented method for ascertaining a control signal of a robot, the method comprising the following steps:
obtaining a position and a movement direction of at least one object in an environment of the robot;
ascertaining a first set of reachable positions of the object with respect to at least one physical model of a movement of the object and a set of time points, wherein the reachable positions of the first set of reachable positions are characterized by a set of first circles, and the first circles are each assigned to a time point from the set of time points;
ascertaining a trajectory of the robot, wherein the trajectory is characterized by positions of the robot at time points from the set of time points, wherein each position is characterized by at least one second circle, which corresponds to the time point of the position;
ascertaining the control signal depending on whether, at a given time point, the second circle corresponding to the given time point intersects with the first circle corresponding to the given time point or touches the first circle corresponding to the given time point.

14. The method according to claim 13, wherein at each time point from the set of time points, a plurality of first circles is ascertained, wherein each first circle of the plurality of first circles is ascertained based on a physical model of a plurality of physical models of the movement of the object, and the control signal is ascertained depending on whether the second circle corresponding to a respective time point of the set of time points intersects with all first circles of the plurality of circles ascertained for the respective time point.

15. The method according to claim 13, wherein each position of the robot along the trajectory is characterized by a plurality of second circles.

16. The method according to claim 15, wherein the control signal is ascertained depending on whether at a given time point from the set of time points, at least one second circle of the plurality of second circles corresponding to the given time point intersects with the first circle corresponding to the given time point.

17. The method according to claim 13, wherein the trajectory is changed and/or the control signal instructs the robot to carry out a safety maneuver, when at at least one time point, a second circle corresponding to the time point intersects with the first circle corresponding to the time point.

18. The method according to claim 13, wherein the set of time points characterizes a period of time required by the robot for performing a safety maneuver.

19. The method according to claim 13, wherein each first circle and/or each second circle characterizes an uncertainty with respect to the position of the object or the position of the robot.

20. The method according to claim 13, wherein radii of two first circles corresponding to consecutive time points, and/or two second corresponding to consecutive time points are selected such that the corresponding first and second circles touch or intersect.

21. A control device, wherein the control device is configured to:
obtain a position and a movement direction of at least one object in an environment of a robot;
ascertain a first set of reachable positions of the object with respect to at least one physical model of the movement of the object and a set of time points, wherein the reachable positions of the first set are characterized by a set of first circles, and the first circles are each assigned to a time point from the set of time points;
ascertain a trajectory of the robot, wherein the trajectory is characterized by positions of the robot at time points from the set of time points, wherein each position is characterized by at least one second circle, which corresponds to the time point of the position;
ascertain the control signal depending on whether, at a given time point, the second circle corresponding to the given time point intersects with the first circle corresponding to the given time point or touches the first circle corresponding to the given time point; and
control the robot in accordance with the control signal.

22. A robot, comprising:
control device configured to:
obtain a position and a movement direction of at least one object in an environment of the robot;
ascertain a first set of reachable positions of the object with respect to at least one physical model of the movement of the object and a set of time points, wherein the reachable positions of the first set are characterized by a set of first circles, and the first circles are each assigned to a time point from the set of time points;
ascertain a trajectory of the robot, wherein the trajectory is characterized by positions of the robot at time points from the set of time points, wherein each position is characterized by at least one second circle, which corresponds to the time point of the position;
ascertain the control signal depending on whether, at a given time point, the second circle corresponding to the given time point intersects with the first circle corresponding to the given time point or touches the first circle corresponding to the given time point; and
control the robot in accordance with the control signal.

23. A non-transitory machine-readable storage medium on which is stored a computer program for ascertaining a control signal of a robot, the computer program, when executed by a processor, causing the processor to perform the following steps:
obtaining a position and a movement direction of at least one object in an environment of the robot;
ascertaining a first set of reachable positions of the object with respect to at least one physical model of the movement of the object and a set of time points, wherein the reachable positions of the first set are characterized by a set of first circles, and the first circles are each assigned to a time point from the set of time points;
ascertaining a trajectory of the robot, wherein the trajectory is characterized by positions of the robot at time points from the set of time points, wherein each position is characterized by at least one second circle, which corresponds to the time point of the position; and
ascertaining the control signal depending on whether, at a given time point, the second circle corresponding to the given time point intersects with the first circle corresponding to the given time point or touches the first circle corresponding to the given time point.
